(19) United States
(12) Patent Application Publication
(10) Pub. No.: US 2025/0373594 A1
(43) Pub. Date: Dec. 4, 2025

(54) RECORDING MEDIUM AND TERMINAL DEVICE

(71) Applicant: Konica Minolta, Inc., Tokyo (JP)

(72) Inventor: Megumi WATAI, Osaka (JP)

(21) Appl. No.: 19/223,713

(22) Filed: May 30, 2025

(30) Foreign Application Priority Data
Jun. 3, 2024 (JP) 2024-090197

(51) Int. Cl. H04L 9/40

(52) U.S. Cl. CPC H04L 63/08

(57) ABSTRACT

Provided is a non-transitory computer-readable recording medium storing an authentication program for causing, in order to perform authentication for using a predetermined function of an image forming apparatus, a computer of a terminal device to: access an authentication server to request user authentication; receive success information indicating that the user authentication is successful from the authentication server; and transmit predetermined information indicating that the user authentication to authenticate a user is successful to the image forming apparatus when receiving the success information.

### CROSS-REFERENCE TO RELATED APPLICATION

The disclosure of Japanese Patent Application No.2024-090197 filed on June 3 , 2024, including description, claims, drawings, and abstract, is incorporated herein by reference in its entirety.

### BACKGROUND OF THE INVENTION

### 1. Technical Field

The present invention relates to a recording medium having recorded thereon an authentication program for operating a computer of a terminal device in order to perform authentication for using a predetermined function of an image forming apparatus, and a terminal device.

### 2. Description of Related art

When a service engineer or the like performs maintenance or the like of an image forming apparatus at a customer’s place, it is common to access a maintenance screen and check the state and settings of the image forming apparatus. The maintenance screen is accessed not by a customer but by a service engineer or the like, so that a fixed password is often used.

However, when a service engineer forgets the password that is shared by a plurality of service engineers or the like, he/she may not be able to log in, which may affect the maintenance of the image forming apparatus. For this reason, the initial password of the image forming apparatus is often fixed, which may cause a risk that a third party pretending to be a user makes an unauthorized login due to leakage or guessing and performs an important operation without permission.

Therefore, it is desirable to make authentication of an individual service engineer, not authentication tied to the image forming apparatus, and leave a trail indicating who has logged in to the image forming apparatus and performed maintenance work.

However, considering that the service engineer or the like is a person outside the company and there are two or more service engineers, it is difficult to store authentication information about each service engineer or the like in the image forming apparatus of the customer. It is better to authenticate the service engineer or the like by external authentication, but the customer may not agree to connect the image forming apparatus to an external network.

Japanese Unexamined Patent Application Publication No. 2012-155647 discloses an image forming system with improved security and convenience. This image forming system can perform authentication and shift an image forming apparatus to a maintenance mode without inputting a password or using a network line connected to the image forming apparatus.

Specifically, this image forming system includes an image forming apparatus, a mobile phone, and an authentication code management server that exchanges an authentication code with the mobile phone. The mobile phone acquires a code for inquiry from the image forming apparatus, and transmits the acquired code to the authentication code management server. When determining that the code is appropriate, the server transmits a corresponding authentication code to the mobile phone, and the image forming apparatus acquires the transmitted authentication code and shifts to the maintenance mode.

Japanese Unexamined Patent Application Publication No. 2017-107461 discloses an image forming system that increases the security level of a maintenance mode.

Specifically, a terminal device specifies an input base code, and then generates and displays an individual password. An image forming apparatus has a function of generating and displaying a base code and authenticating an input individual password. The image forming apparatus performs authentication based on a legitimate individual password, and switches to a maintenance mode if the password is valid.

The image forming systems described in the above-described publications have problems that authentication information is generated on the image forming apparatus, and impersonation is possible if an authentication code is found (it is not possible to ensure who has accessed).

### SUMMARY OF THE INVENTION

An object of the present invention is to provide a recording medium having recorded thereon an authentication program capable of performing high-security authentication when a service engineer or the like uses a predetermined function of an image forming apparatus, and a terminal device.

A first aspect of the present invention relates to

a non-transitory computer-readable recording medium storing an authentication program for causing, in order to perform authentication for using a predetermined function of an image forming apparatus, a computer of a terminal device to:

access an authentication server to request user authentication;

receive success information indicating that the user authentication is successful from the authentication server; and

transmit predetermined information indicating that the user authentication to authenticate a user is successful to the image forming apparatus when receiving the success information.

A second aspect of the present invention relates to

a terminal device for performing authentication for using a predetermined function of an image forming apparatus,

the terminal device including a hardware processor, wherein the hardware processor:

accesses an authentication server to request user authentication;

receives success information indicating that the user authentication is successful from the authentication server; and

transmits predetermined information indicating that the user authentication to authenticate a user is successful to the image forming apparatus when receiving the success information.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a block diagram illustrating a functional configuration of an authentication system including a terminal device according to an embodiment of the present invention;

FIG. 2 is a sequence diagram illustrating the operation of the authentication system illustrated in FIG. 1;

FIG. 3 is a diagram illustrating a login screen to an image-forming-apparatus maintenance app displayed on the terminal device;

FIG. 4 is a diagram illustrating a screen indicating the detail of the image-forming-apparatus maintenance app displayed on the terminal device;

FIG. 5 is a table illustrating an example of a work log;

FIG. 6A is a diagram illustrating a login screen to an image-forming-apparatus login service app displayed on the terminal device; and FIG. 6B is a diagram illustrating a screen illustrating the detail of the image-forming-apparatus login service app.

### DETAILED DESCRIPTION

Hereinafter, one or more embodiments of the present invention will be described with reference to the drawings. However, the scope of the invention is not limited to the disclosed embodiments.

An embodiment of the present invention will be described below with reference to the drawings.

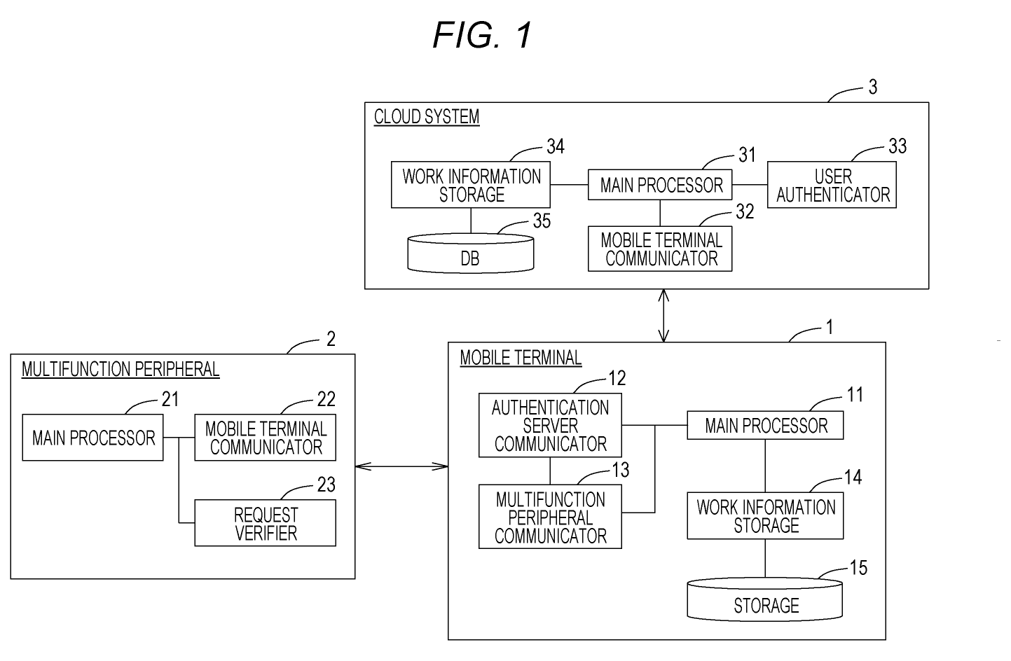

FIG. 1 is a block diagram illustrating a functional configuration of an authentication system including a terminal device according to an embodiment of the present invention.

The authentication system includes a terminal device 1, an image forming apparatus 2, an authentication server 3, and the like.

The terminal device 1 is a mobile terminal such as a smartphone or a tablet in the present embodiment, but may be a personal computer or the like. It is to be noted, however, that the terminal device 1 is desirably a terminal that can be carried by a user such as a service engineer of a manufacturer of the image forming apparatus 2. In the following description, the terminal device is also referred to as a mobile terminal.

In the present embodiment, the image forming apparatus 2 is a digital multifunction peripheral (MFP) having a copy function, a printer function, a scan function, a facsimile function, and the like. In the following description, the image forming apparatus is also referred to as a multifunction peripheral.

In the present embodiment, the mobile terminal 1 is a company-owned mobile terminal that the manufacturer of the multifunction peripheral 2 lends to a service engineer or the like belonging to the company. As illustrated in FIG. 1, the mobile terminal 1 includes a main processor 11, an authentication server communicator 12, a multifunction peripheral communicator 13, a work information storage 14, a storage 15, and the like. Note that, although the mobile terminal 1 is equipped with general functions as a mobile terminal, FIG. 1 mainly illustrates only functions related to user authentication.

The main processor 11 includes a computer system such as a CPU which is a hardware processor, a ROM, and a RAM, and performs overall control and processing of the entire mobile terminal 1.

The authentication server communicator 12 is an interface for connection with the authentication server 3 via a network. The multifunction peripheral communicator 13 is an interface for communicating with the multifunction peripheral 2.

The work information storage 14 stores, in the storage 15, work information created by a service engineer or transmitted from the multifunction peripheral 2 after the service engineer or the like is permitted to log in to the multifunction peripheral 2 and performs work such as maintenance of the multifunction peripheral 2.

Note that the storage 15 stores various kinds of data in addition to the work information. The storage 15 stores, for example, a program (application) for the main processor 11 to perform control and processing, information regarding a service engineer who carries the mobile terminal 1, success information indicating that user authentication received from the authentication server 3 has succeeded, and the like. The success information will be described later.

As illustrated in FIG. 1, the multifunction peripheral 2 includes a main processor 21, a mobile terminal communicator 22, a request verifier 23, and the like. Note that the multifunction peripheral 2 is equipped with general functions as a multifunction peripheral, such as a copy function, a printer function, a scan function, and a facsimile function, but FIG. 1 mainly illustrates only functions related to user authentication.

The main processor 21 includes a CPU, a ROM, a RAM, and the like, and performs overall control and processing of the entire multifunction peripheral 2.

The mobile terminal communicator 22 is an interface for communicating with the mobile terminal 1. The request verifier 23 verifies the validity of predetermined information transmitted from the mobile terminal 1 and indicating that the user authentication has succeeded. The verification of the validity will be described later.

The authentication server 3 is configured as a cloud system (cloud server) in the present embodiment. In the following description, the authentication server is also referred to as a cloud system.

In the present embodiment, the cloud system 3 is a maintenance server that is managed and operated by a manufacturer of the multifunction peripheral 2 and that centrally manages the multifunction peripherals 2 installed in customer companies. The cloud system 3 includes a main processor 31, a mobile terminal communicator 32, a user authenticator 33, a work information storage 34, a database (DB) 35, and the like. Although the cloud system 3 is provided with a general function as an authentication server, FIG. 1 mainly illustrates a function related to user authentication.

The main processor 31 includes a CPU, a ROM, a RAM, and the like, and performs overall control and processing of the entire cloud system 3.

The mobile terminal communicator 32 is an interface for communicating with the mobile terminal 1.

The user authenticator 33 performs user authentication to authenticate a service engineer who carries the mobile terminal 1. The user authentication is performed by collating the authentication information transmitted from the mobile terminal 1 with authentication information held by the cloud system 3.

The work information storage 34 stores the work information transmitted from the mobile terminal 1 in the database 35 in association with the user. Note that the database 35 stores, in addition to the work information, authentication information for each of a plurality of users, and the like.

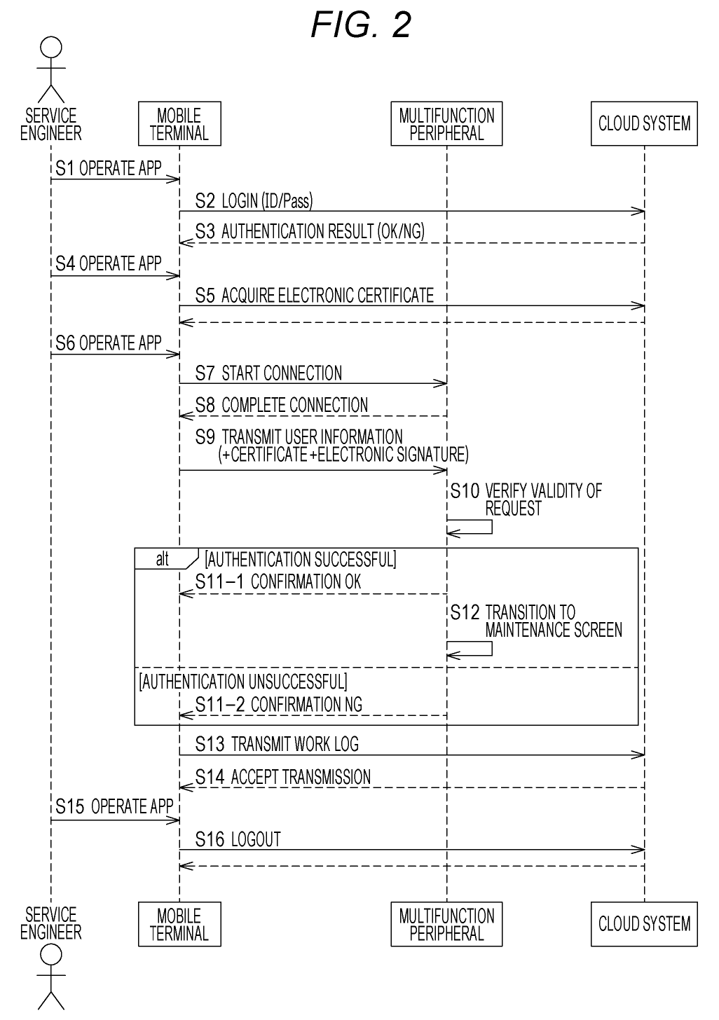

The operation of the authentication system illustrated in FIG. 1 will be described with reference to the sequence diagram of FIG. 2.

The service engineer starts an application (hereinafter, also simply referred to as app) that runs on the mobile terminal 1 (step S1). The subsequent operations of the mobile terminal 1 are executed by the CPU, which is a hardware processor of the main processor 11, operating in accordance with an operation program (application) stored in the storage 15 or the like in response to an operation by the service engineer.

Next, the service engineer operates the mobile terminal 1 to send identification information (ID) and a password (Pass) to the authentication service on the cloud system 3 managed by the same manufacturer as the multifunction peripheral 2 and request login processing (step S2). The mobile terminal 1 and the cloud system 3 communicate with each other by communication using a general mobile-phone line, and the content of communication is encrypted by HTTPS.

An authentication result is returned from the cloud system 3 to the mobile terminal 1 (step S3). When the authentication is successful, the service engineer can use the function of the app on the mobile terminal 1. When the authentication is unsuccessful, the function of the app is not available.

The service engineer operates the app of the mobile terminal 1 (step S4) to request acquisition of an electronic certificate created by the manufacturer of the multifunction peripheral (step S5). The cloud system 3 transmits the electronic certificate to the mobile terminal 1, and the mobile terminal 1 receives the electronic certificate (step S5). This electronic certificate is issued by a reliable certificate authority.

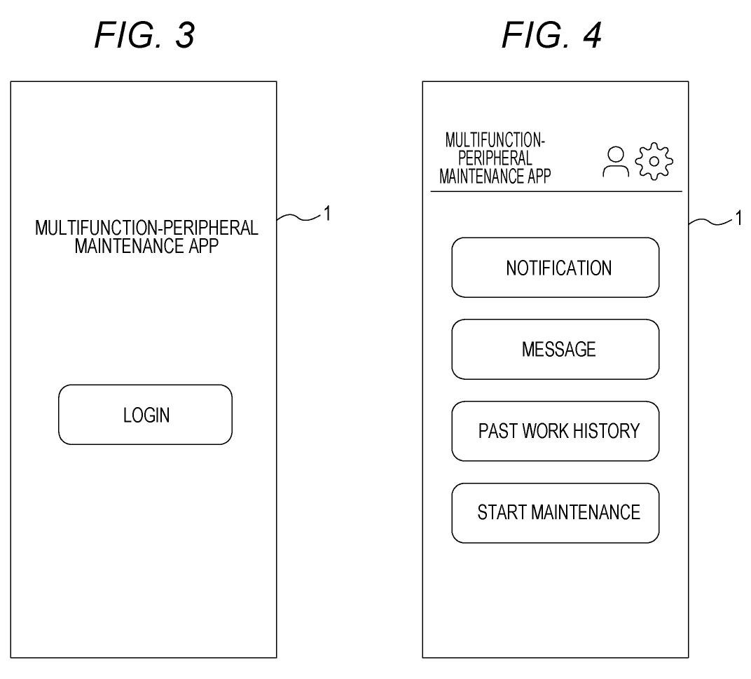

Next, the service engineer displays a login screen (illustrated in FIG. 3) to log in to a multifunction-peripheral maintenance app installed in the mobile terminal 1, and presses a “login” button on the login screen (step S6). Next, the service engineer inputs identification information (ID) and a password set by himself/herself in advance.

Then, a screen of the multifunction-peripheral maintenance app as illustrated in FIG. 4 is displayed. On this screen, buttons of “notification”, “message”, “past work history”, and “start maintenance” are displayed.

When the service engineer presses the “start maintenance” button, a function for starting the maintenance work is activated, and the mobile terminal 1 starts connection with the multifunction peripheral 2 (step S7). As a communication method, wireless communication using Bluetooth (registered trademark), communication using a wired cable, or the like is conceivable.

When the connection is completed, the multifunction peripheral 2 transmits a connection completion notification to the mobile terminal 1 (step S8), and the mobile terminal 1 receives the connection completion notification.

After completing the connection with the multifunction peripheral 2, the mobile terminal 1 transmits user information regarding the service engineer to the multifunction peripheral 2 (step S9). The mobile terminal 1 simultaneously transmits an electronic signature (known technique) and an electronic certificate (known technique) for the user information to the multifunction peripheral 2 in order to prove the validity of the user information and the validity of the communication partner.

The multifunction peripheral 2 verifies the validity of the data sent from the mobile terminal 1 (step S10). Due to the verification of the validity, the multifunction peripheral 2 can detect falsification of the user information and verify whether or not the data has been sent from a valid partner.

The multifunction peripheral 2 notifies the mobile terminal 1 of the verification result. That is, when determining that the data is valid, the multifunction peripheral 2 gives a notification indicating that the confirmation is OK (authentication is successful) to the mobile terminal 1 (step S11-1). Then, the multifunction peripheral 2 changes the display screen to a maintenance screen (step S12). The service engineer can perform maintenance of the multifunction peripheral 2 using the maintenance screen displayed on the multifunction peripheral 2.

When determining that the data is not valid, the multifunction peripheral 2 gives a notification indicating that the confirmation is NG (authentication is unsuccessful) to the mobile terminal 1 (step S11-2). In this case, the login to the multifunction peripheral 2 is disabled, and the maintenance screen is not displayed on the multifunction peripheral 2. Therefore, the service engineer cannot perform maintenance on the multifunction peripheral 2. The case where the data transmitted from the mobile terminal 1 to the multifunction peripheral 2 is not valid indicates a state where the service engineer has not been authenticated. Therefore, the access to the multifunction peripheral 2 by a third party or the like pretending to be a service engineer is prevented.

After completing the work, the service engineer may create a work log as work information with the mobile terminal 1 and store the created work log in the storage 15 via the work information storage 14. The work log may be transmitted from the mobile terminal 1 to the cloud system 3 (step S13).

Furthermore, the mobile terminal 1 may acquire, from the multifunction peripheral 2, the details of the work actually performed in the multifunction peripheral 2, and store, as a work log, the details in the storage 15 via the work information storage 14. The work log may be transmitted from the mobile terminal 1 to the cloud system 3 (step S13).

The cloud system 3 that has received the work log from the mobile terminal 1 gives a notification indicating that the work log has been received to the mobile terminal 1 (step S14).

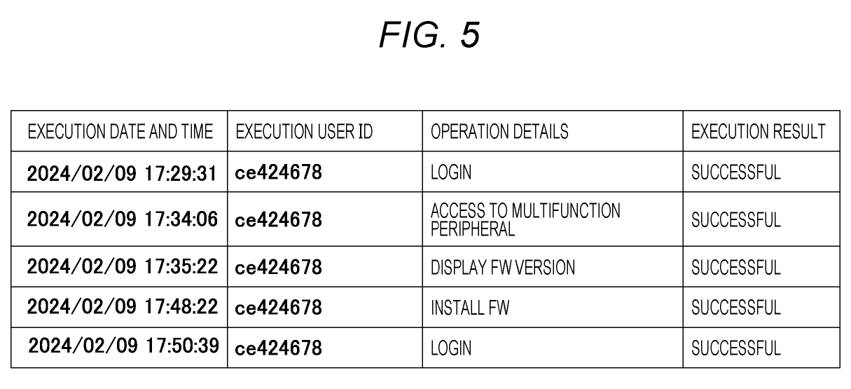

Note that the work log stored in the storage 15 of the mobile terminal 1 can be viewed by pressing the “past work history” button on the screen in FIG. 4. FIG. 5 illustrates an example of a work log stored in the storage 15. This example illustrates that, in the work log, an execution user ID, an operation detail, and an execution result are displayed in time series.

After completing the maintenance work, the service engineer operates the app of the mobile terminal 1 (step S15) and logs out from the cloud system 3 (step S16). At the timing of logout, the certificate acquired from the cloud system 3 may be deleted.

Note that in the present embodiment, after logging in to the cloud system 3, the service engineer continues to log in to the cloud system 3 until finishing the maintenance work for the multifunction peripheral 2. On the other hand, the service engineer may log out after acquiring the electronic certificate from the cloud system 3 and before starting the maintenance work. However, continuing the login state provides an advantage that the service engineer does not need to perform the login operation again for transmitting the work log to the cloud system 3.

As described above, the present embodiment does not need to generate authentication information on the multifunction peripheral 2 and also does not need to establish network connection with an external authentication device outside the multifunction peripheral 2 for authentication for the service engineer or the like to use a predetermined function of the multifunction peripheral 2. In addition, the user authentication to authenticate a service engineer or the like is performed in the cloud system 3, whereby the user authentication has a high level of security. Therefore, impersonation or the like by a third party can be prevented, and a legitimate service engineer or the like whose identity is guaranteed can be permitted to use a predetermined function of the multifunction peripheral 2.

Note that in a case where the identification information (ID) or the password of the service engineer is leaked, the cloud system 3 disables an account, and the disabled account is not allowed to log in to the cloud system 3. Therefore, the mobile terminal 1 cannot acquire the electronic certificate issued by the cloud system 3, and thus, the mobile terminal 1 cannot log in to the multifunction peripheral 2.

The above embodiment has described the example in which the user authentication to authenticate the service engineer is performed. An example in which the customer company uses the user authentication will be described below.

As described above, some customers may have a multifunction peripheral 2 that is not connected to a network such as the Internet due to security requirements or the like. For such a multifunction peripheral 2, a customer user such as an employee logs in to the cloud system 3 instead using the mobile terminal 1 and transmits the result of login to the multifunction peripheral 2. Thus, a login to the multifunction peripheral 2 is enabled.

Specifically, the customer user operates the mobile terminal 1 to transmit identification information (ID) and a password (Pass) to the cloud system 3 and request the cloud system 3 to perform login processing. The subsequent processes and operations are the same as those in the example illustrated in the sequence diagram illustrated in FIG. 2, and when the authentication is successful, the mobile terminal 1 receives and acquires an electronic certificate from the cloud system 3.

The constituent elements for implementing this system are the same as those in FIG. 1, but are different in that the mobile terminal 1 is owned and managed by the customer company, and the authentication information about the customer user is stored in the cloud system 3 serving as the authentication destination server.

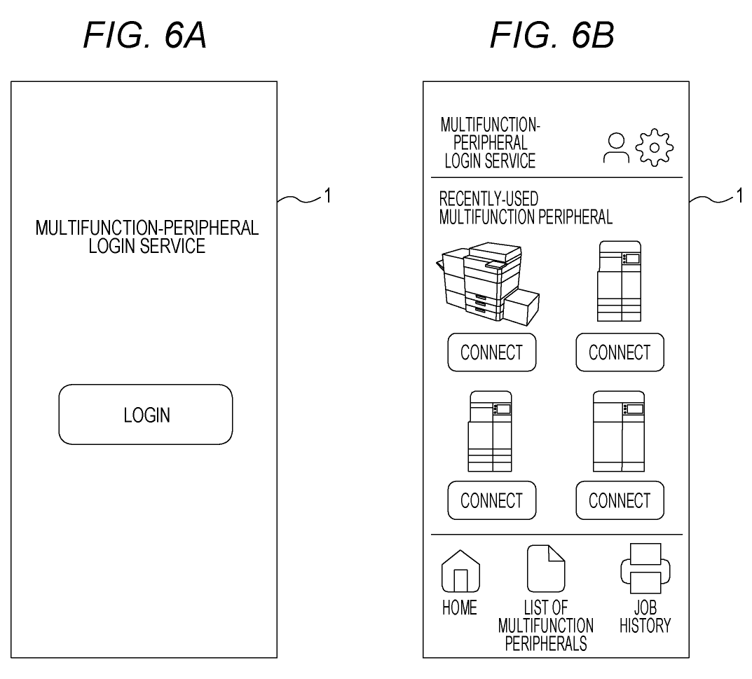

When using a multifunction-peripheral login service app installed in the mobile terminal 1, the customer user operates the mobile terminal 1 to display a login screen to the multifunction-peripheral login service app. FIG. 6A illustrates an example of the login screen. The customer user presses a “login” button on the login screen, and inputs identification information (ID) and a password set by the customer user himself/herself in advance.

Then, the screen of the multifunction-peripheral login service app illustrated in FIG. 6B is displayed. On this screen, information about a plurality of recently used multifunction peripherals 2 and the like are displayed. When the customer user selects the multi-function peripheral 2 to be connected, the mobile terminal 1 starts connection with the selected multifunction peripheral 2.

When the connection is completed, the multifunction peripheral 2 transmits a connection completion notification to the mobile terminal 1, and the mobile terminal 1 receives the connection completion notification. The mobile terminal 1 transmits user information regarding the customer user to the multifunction peripheral 2 after the completion of connection with the multifunction peripheral 2. The mobile terminal 1 simultaneously transmits an electronic signature (known technique) and an electronic certificate (known technique) for the user information to the multifunction peripheral in order to prove the validity of the user information and the validity of the communication partner.

The multifunction peripheral 2 verifies the validity of the data sent from the mobile terminal 1, and notifies the mobile terminal 1 of the verification result. That is, when determining that the data is valid, the multifunction peripheral 2 gives a notification indicating that the confirmation is OK (authentication is successful) to the mobile terminal 1. Then, the multifunction peripheral 2 changes the display screen to an operation screen. The customer user can use the multifunction peripheral 2 by using the operation screen displayed on the multifunction peripheral 2. That is, a login to the multifunction peripheral 2 is enabled.

When determining that the data is not valid, the multifunction peripheral 2 gives a notification indicating that the confirmation is NG (authentication is unsuccessful) to the mobile terminal 1. In this case, the login to the multifunction peripheral 2 is disabled, and the operation screen is not displayed on the multifunction peripheral 2. Therefore, the customer user cannot use the multifunction peripheral 2. Accordingly, it is possible to prevent a login to the multifunction peripheral by a third party or the like pretending to be the user.

Furthermore, in the embodiment illustrated in FIG. 2, the log (work log) of the detail of the maintenance work performed by the service engineer is acquired and saved in the storage 15 of the mobile terminal 1. In the embodiment in which the customer company uses user authentication, the mobile terminal 1 may acquire a log of a job operation performed by the user and store the log in the storage 15.

Although one or more embodiments of the present invention have been described and illustrated in detail, the disclosed embodiments are made for purposes of illustration and example only and not limitation. The scope of the present invention should be interpreted by terms of the appended claims.

What is claimed is:

1. A non-transitory computer-readable recording medium storing an authentication program for causing, in order to perform authentication for using a predetermined function of an image forming apparatus, a computer of a terminal device to:
access an authentication server to request user authentication;
receive success information indicating that the user authentication is successful from the authentication server; and
transmit predetermined information indicating that the user authentication to authenticate a user is successful to the image forming apparatus when receiving the success information.

2. The non-transitory computer-readable recording medium according to claim 1, wherein the program further causes the computer to: acquire from the image forming apparatus, details of an operation performed at the time of maintenance of the image forming apparatus; and store, as a work log, the acquired details of the operation in association with the user that has been authenticated by the user authentication.

3. The non-transitory computer-readable recording medium according to claim 2, wherein the program further causes the computer to transmit the work log to an external device.

4. The non-transitory computer-readable recording medium according to claim 1, wherein, when the user authentication by the authentication server is not successful, a login to the image forming apparatus is disabled.

5. A terminal device for performing authentication for using a predetermined function of an image forming apparatus,
the terminal device comprising a hardware processor, wherein the hardware processor:
accesses an authentication server to request user authentication;
receives success information indicating that the user authentication is successful from the authentication server; and
transmits predetermined information indicating that the user authentication to authenticate a user is successful to the image forming apparatus when receiving the success information.

6. The terminal device according to claim 5, wherein the hardware processor:
acquires, from the image forming apparatus, details of an operation performed at the time of maintenance of the image forming apparatus; and stores, as a work log, the acquired details of the operation in a storage in association with the user that has been authenticated by the user authentication.

7. The terminal device according to claim 6, wherein the hardware processor transmits the work log to an external device.

8. The terminal device according to claim 5, wherein, when the user authentication by the authentication server is not successful, a login to the image forming apparatus is disabled.
